(19) United States
(12) Patent Application Publication
(10) Pub. No.: US 2004/0045412 A1
(43) Pub. Date: Mar. 11, 2004

(54) Slide hammer confidential and proprietary document

(76) Inventor: Terry Lee Cotner, Warrenton, MO (US)

Correspondence Address: Henry W. Cummings, 3313 W. Adams St., St. Charles, MO, 63301, US

(21) Appl. No.: 10/237,429

(22) Filed: Sep. 10, 2002

(51) Int. Cl. B25D 1/16

(52) U.S. Cl. 81/27

(57) ABSTRACT

The present invention comprises a strong sleeve with a strong sliding member which concentrates force at the end farthest from the user in order to reshape the workpiece.

### I FIELD OF THE INVENTION

This invention relates to power tools, and specifically to slide hammers.

### II BACKGROUND OF THE INVENTION

During the course of metal body working including, but not limited to, auto body repair, force must be applied to deformed sheet metal and/or structural member (herafter referred to as the workpiece) to move it back into its proper position. Slide hammers are well known in the art, having been used for a number of years. The majority of them are large, heavy, and cumbersome, making them difficult for one person to handle and difficult to use in confined spaces.

The present invention provides a simple, lightweight, inexpensive, and compact means of applying force to an object.

U.S. Pat. No. 6,125,719 discloses a prior art slide hammer. This device uses spring loaded parts, adding to its complexity and presenting a possiblity of malfunction. In addition, this device is many times heavier and more expensive than the present invention.

### III SUMMARY OF THE INVENTION

### A. OBJECTS OF THE INVENTION

One object of the present invention is to provide a means to apply force to a workpiece to bend it back to its original shape.

Another object of the present invention is to provide a means to apply force to a workpiece to bend it back to its original shape.

Another object of the present invention is to provide a device that is light and is easily used by one person.

Another object of the present invention is to provide a device that can be used in confined spaces.

Another object of the present invention is to be inexpensive.

Other objects will be apparent from the following Descriptions and Drawings.

### SUMMARY

The present invention comprises a strong sleeve with a heavy, sliding member which concentrates force at the end farthest from the user in order to reshape the workpiece.

### IV. THE DRAWINGS

FIG. 1 is a perspective view of all major elements of the present invention.

FIG. 2 is a perspective view of the present invention, showing its relative size as compared with existing devices.

FIG. 3 is a perspective view of the slide.

FIG. 4 is a perspective view of the sleeve.

FIG. 5 is a perspective view of the chain accessory.

FIG. 6 is a perspective view of the extension accessory.

FIG. 7 is perspective views of the head accessories.

FIGS. 8A and 8B are perspective views of the present invention, showing it in use.

### V. DESCRIPTION OF PREFERRED EMBODIMENTS

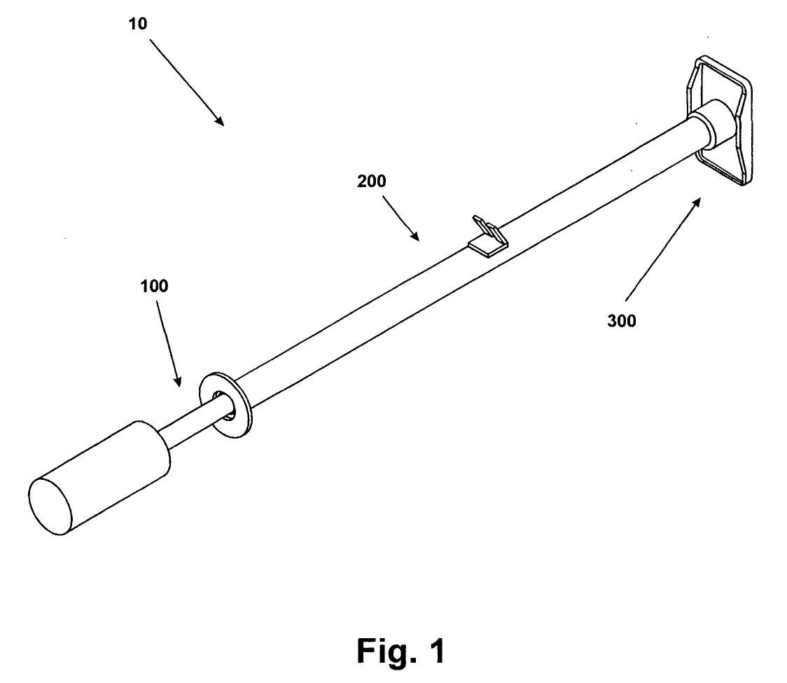

In accordance with the present invention, FIG. 1 shows a perspective view of the present invention, generally at 10. The three major sections of the present invention comprise slide 100, sleeve 200, and head 300.

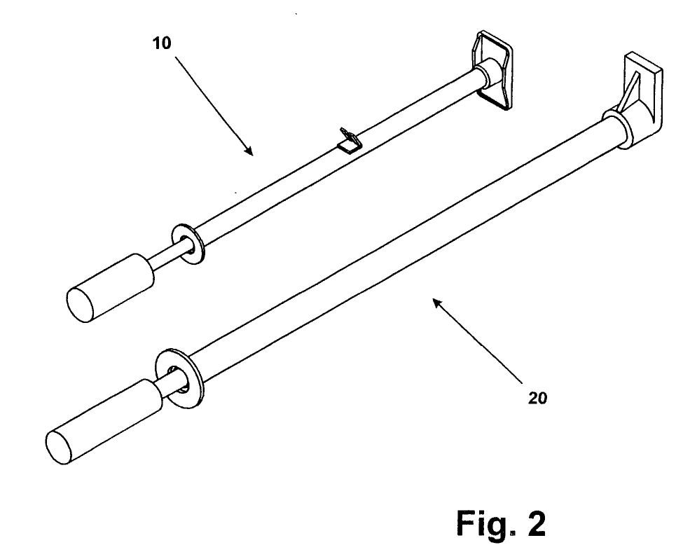

FIG. 2 shows the relative size of the present invention 10 as compared with an example of a competitive, prior art device 20. As can be seen, the present invention is considerably lighter and more compact than the prior art device.

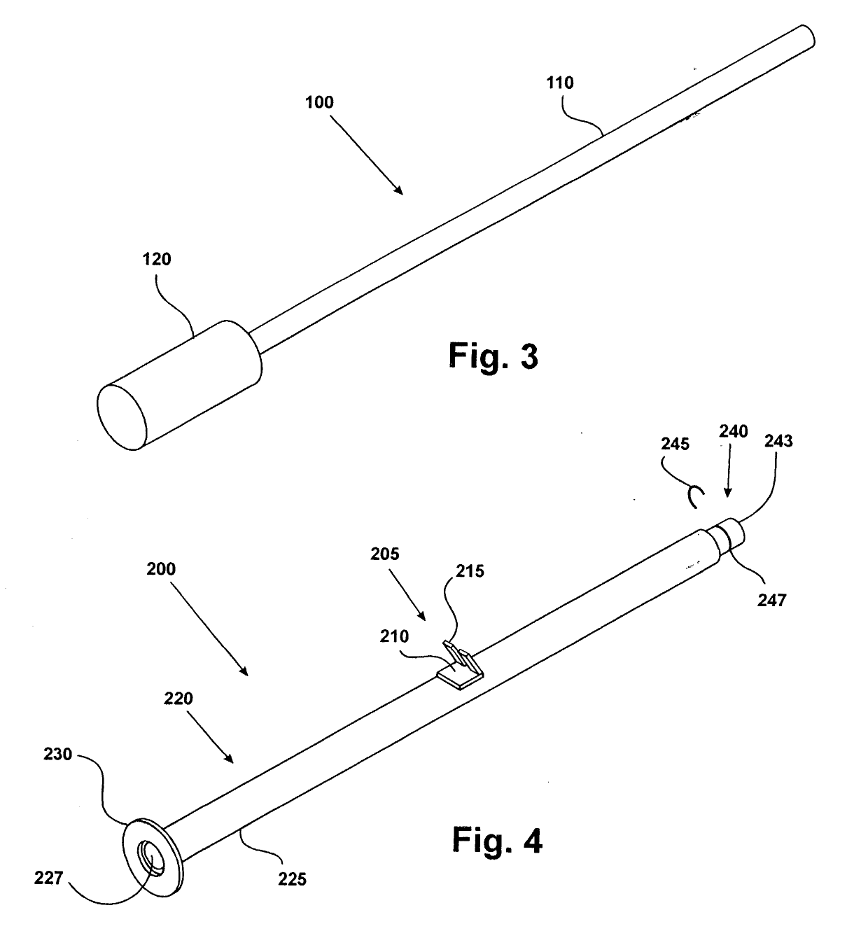

Slide 100 (FIG. 3) comprises handle 120, which is made of steel or other metal, plastic or composite strong material. Handle 120 may be covered with a spongy material to provide a good grip and comfort for the user. Shaft 110 is also made of steel or other metal, plastic or composite strong material. Shaft is permanently or removably attached to handle 120 by means of welding, interference fit, or mechanical fasteners etc.

Sleeve 200 (FIG. 4) comprises body 220, chain anchor 205, and anvil 240. All components are made of steel or other strong, durable material.

Body 220 has an outer diameter 225, and an inner diameter 227 which is just slightly larger than the diameter of shaft 110, allowing shaft 110 to move freely in and out of sleeve 200.

Flange 230 is permanently attached to body 220 by means of welding, interference fit, etc. The purpose of flange 230 is to provide a means to allow the user to retain a grip on the tool without being injured by its operation.

Chain anchor 205 comprises flat surface 210 and angled forked surface 215. Flat surface 210 is permanently attached to body 220 by means of welding. Angled forked surface 215 projects upward at an acute angle and provides an anchoring means for chain 500. Anvil 240 comprises plug 243 which is permanently attached to one end of body 220 by means of welding, interference fit, etc. Groove 247 accepts “C” ring 245.

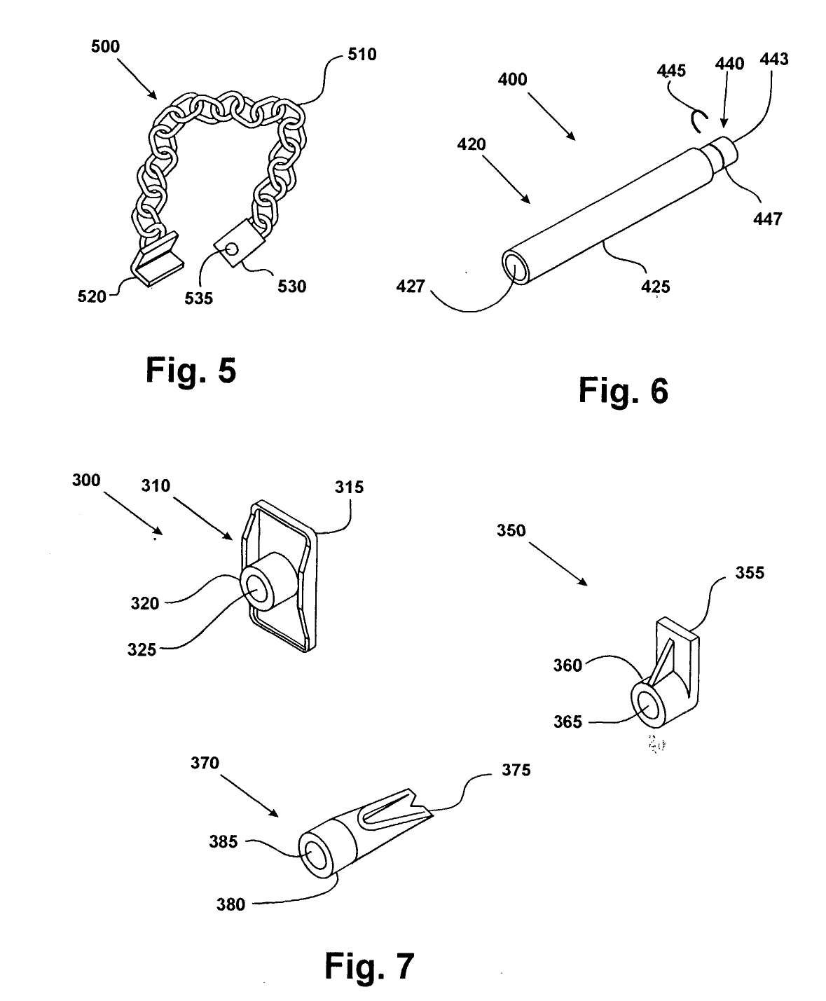

FIG. 5 shows chain accessory 500, which comprises a plurality of links 510, a large end 520 and a small end 530. Large end 520 is bent at an acute angle (less than 90 degrees) to afford a grip on a workpiece. Small end 530 includes hole 535 to afford attaching chain accessory 500 to a protrusion such as a stud or bolt.

FIG. 6 shows extension accessory 400, which comprises extension body 420 and extension anvil 440. Extension body 420 is a hollow tube made of steel or other strong and durable material. Extension body 420 has an outer diameter 425 and an inner diameter 427, which is just slightly larger than the diameter of plug 243, allowing extension accessory 400 to be removably attached to sleeve 200 and held in place by “C” ring 245. Extension anvil 440 comprises extension plug 443 which is permanently attached to one end of extension body 420 by means of welding, interference fit, etc. Extension plug 443 has a groove 447, which accepts extension “C” ring 445.

FIG. 7 shows head accessories 300, which comprise large head 310, small head 350, and chisel head 370.

Large head 310 comprises foot 315, receiving section 320, and inner diameter 325. Foot 315 is the part of the component which makes contact with the workpiece.

Receiving section 320 is generally the same diameter as body 220, and inner diameter 325 is slightly larger than plug 243. When large head 310 is attached to anvil 240 or extension anvil 440, it is held in place by “C” ring 245 or extension “C” ring 445, respectively. Small head 350 comprises foot 355, receiving section 360, and inner diameter 365. Foot 355 is the part of the component which makes contact with the workpiece to be straightened.

Receiving section 360 is generally the same diameter as body 220, and inner diameter 365 is slightly larger than plug 243. When small head 350 is attached to anvil 240 or extension anvil 440, it is held in place by “C” ring 245 or extension “C” ring 445, respectively. Chisel head 370 comprises chisel 375, receiving section 380, and inner diameter 385.

Chisel 375 is the part of the component which makes contact with the workpiece.

Receiving section 380 is generally the same diameter as body 220, and inner diameter 385 is slightly larger than plug 243. When chisel head 370 is attached to anvil 240 or extension anvil 440, it is held in place by “C” ring 245 or extension “C” ring 445, respectively.

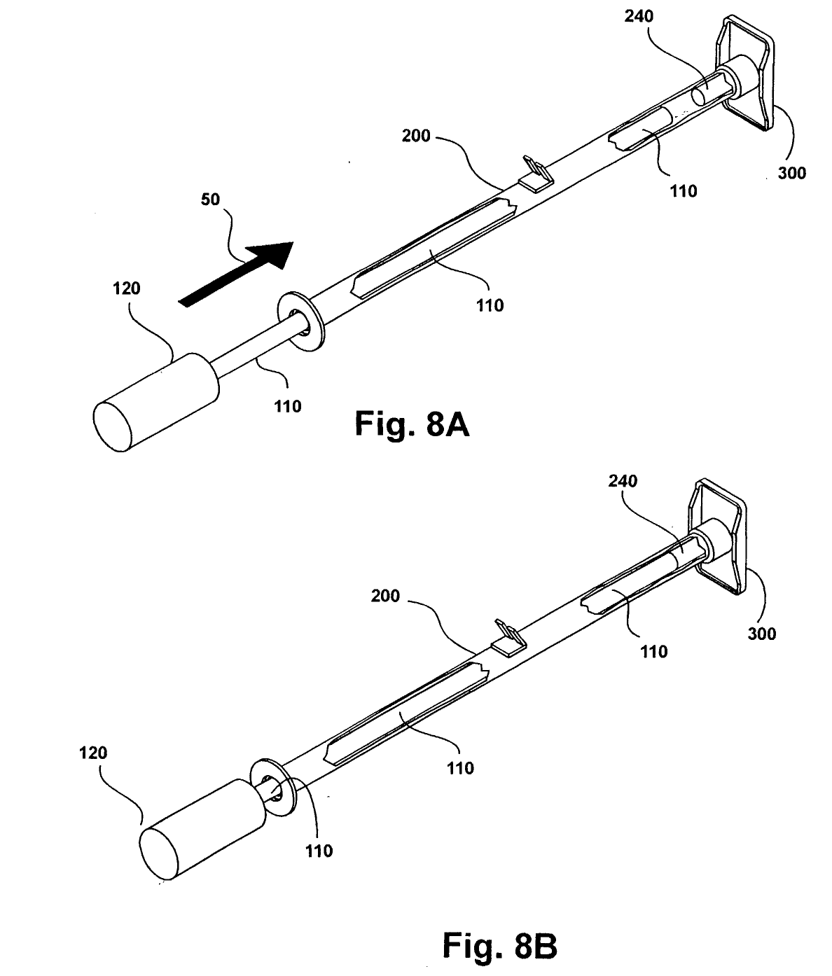

In FIG. 8A, slide 100 is shown inserted into the open end of sleeve 200. One of the heads 300 is attached to plug 243 and held in place by “C” ring 245. The operator rapidly pushes slide 100 down sleeve 200 in the direction shown by arrow 50. Shaft 110 is shown approaching, but not contacting anvil 240.

In FIG. 8B, shaft 110 is shown in contact with anvil 240. The kinetic energy produced by the rapid movement of the weighted handle 120 is transferred down shaft 110, to anvil 240, to head 300, and to the workpiece.

If the user desires to impart a twisting force to the workpiece, chain accessory is used. One link 510 is hooked over angled forked surface 215 of chain anchor 205. Depending upon the nature of the workpiece, either large end 520 or small end 530 is fastened to the workpiece. The user can then impart a twisting action or a twisting action combined with normal slide hammer operation as previously described.

What is claimed is:

1. A precise strike tool comprising:
a slide,
a sleeve,
a variety of heads,
an extension, and
a chain accessory.

2. A precise strike tool according to claim 1 having a slide comprising a shaft and handle assembly.

3. A precise strike tool according to claim 1 having a sleeve comprising a body, a flange, a chain anchor, and an anvil.

4. A precise strike tool according to claim 1 having a variety of heads, including but not limited to: a large head, a small head, and a chisel.

5. A precise strike tool according to claim 1 having an extension comprising an extension body and an extension anvil.

6. A precise strike tool according to claim 1 having a chain accessory comprising a large end and a small end connected by and welded to a plurality of links.

7. A precise strike tool according to claim 2 wherein said shaft is made of smooth solid material and is of sufficient length to impart a striking force.

8. A precise strike tool according to claim 2 wherein said handle is permanently or removably attached to said shaft.

9. A precise strike tool according to claim 3 wherein said body has a smooth interior diameter slightly larger than said shaft, allowing the shaft to freely move longitudinally within the sleeve.

10. A precise strike tool according to claim 3 wherein said flange affords the user a secure handhold and reduces the possiblity of injury when said slide is forcibly moved down said sleeve.

11. A precise strike tool according to claim 3 wherein said chain anchor has a straight portion which is permanently attached to said body, and an angled portion.

12. A precise strike tool according to claim 11 wherein said chain anchor provides means to attach a chain accessory.

13. A precise strike tool according to claim 11 wherein the angled portion of said chain anchor is forked to capture the chain accessory.

14. A precise strike tool according to claim 3 wherein said anvil is permanently attached to one end of said body.

15. A precise strike tool according to claim 14 wherein said anvil has a smooth outer diameter to accept one of a variety of heads.

16. A precise strike tool according to claim 4 wherein said heads comprise a variety of sizes and shapes.

17. A precise strike tool according to claim 5 wherein said extension body is a shorter version of said shaft body.

18. A precise strike tool according to claim 17 wherein said extension body has an inner diameter which allows it to fit over said anvil.

19. A precise strike tool according to claim 5 wherein said anvil has a smooth outer diameter to accept one of a variety of heads, said head is retained by means of a “C” ring fitted inside a groove in said anvil.

20. A precise strike tool according to claim 6 wherein said large end is bent at an acute angle to facilitate gripping a workpiece.

21. A precise strike tool according to claim 6 wherein said small end includes a hole to facilitate gripping a workpiece.

22. A precise strike tool according to claim 6 wherein said chain is comprised of by a plurality of links made of material of sufficient strenght to withstand a twisting force by the user.

23. A precise strike tool according to claim 7 wherein said a shaft and handle assembly are made from a material selected from the group consisting of steel, aluminum alloy, composite material or other strong, durable material.

24. A precise strike tool according to claim 8 wherein said handle is attached to said shaft by means of welding, interference fit or mechanical fasteners.

25. A precise strike tool according to claim 15 wherein said head is retained by means of a “C” ring fitted inside a groove in said anvil.

26. A precise strike tool according to claim 19 wherein said head is retained by means of a “C” ring fitted inside a groove in said anvil.
